(19) United States
(12) Patent Application Publication
(10) Pub. No.: US 2002/0021353 A1
(43) Pub. Date: Feb. 21, 2002

(54) Streaming panoramic video

(76) Inventor: Mark DeNies, Lake Oswego, OR (US)

Correspondence Address: Elmer Galbi, Esq., 13314 Vermeer Drive, Lake Oswego, OR, 97035, US

(21) Appl. No.: 09/877,166

(22) Filed: Jun. 8, 2001

Related U.S. Application Data
(60) Provisional application No. 60/210,374, filed on Jun. 9, 2000.

(51) Int. Cl. H04N 7/00; H04N 7/173; G06T 1/00; G06F 17/00

(52) U.S. Cl. 348/36; 725/87; 345/418

(57) ABSTRACT

Streaming panoramic images from a server to a client. The system utilizes a special program at the client and a special program in the server. The special program at the client communicates with the special program at the server to direct which portion of the panorama should be streamed to the client. The special program at the client has the ability to accept data that represents a portion of a series of panoramic frames, to decompress the data, to select the data that constitutes an appropriate view window and to render a portion of each frame on a screen or display. The special program at the server selects particular slices that constitute a region of interest in the panorama and these slices are sent to the client. When the location of the view window is changed by more than a threshold amount, the client sends a command back to the web server to adjusts the selection of the slices that are streamed from the server to the client.

### RELATED APPLICATION

The present application is a continuation in part of application 60/210,374 filed Jun. 9, 2000.

### FIELD OF THE INVENTION

The present invention relates to the transmission of panoramic images and more particularly to transferring portions of panoramic images from a server to a client using “video streaming”.

### BACKGROUND OF THE INVENTION

It is well known that special provisions are required when viewing panoramic images on a computer display. If an entire panoramic image is projected on a computer display, the image is necessarily distorted. Panoramic images are generally viewed using a viewer program which renders (i.e. displays) a portion of the panorama on a screen or display. The portion of the panorama that is displayed is generally termed a “view window”. Generally viewer programs provide a mechanism (such as a mouse) that can be used to select the desired portion of the panorama frame that constitutes the view window.

A panoramic video (or a panoramic movie) is a series of panoramic frames, each of which contains a panoramic image. Co-pending patent application Ser. No. 09/310,715 filed May 12, 1999 entitled “Panoramic Movies which Simulate Movement Through Multidimensional Space” describes a system for displaying a panoramic video by displaying a view window that displays in sequence substantially the same view window from a series of panoramic images. The view window only gradually changes location between frames as the viewer chooses to change the direction of view.

Storing a panoramic video requires a great deal of storage, hence, a large amount of bandwidth is required in order to stream panoramic images from a web server to a client. The present invention is directed to reducing the bandwidth required to stream panoramic images from a web server to a client. With the present invention panoramic images can be streamed from a web server to a client over a lower bandwidth connection or with greater image quality, size, and/or frame rate.

The MPEG video compression standard provides a “slicing” mechanism. This mechanism is generally used in order to facilitate error correction. The present invention utilizes the slicing mechanism in the MPEG video compression standard to reduce the bandwidth required to stream panoramic video from a web server to a client.

### SUMMARY OF THE INVENTION

The present invention streams panoramic images from a server to a client. The system utilizes a special module at the client and a special module in the server. The special modules may be plug-ins for commercially available streaming programs. The special module at the client provides the functions that are typically provided by a conventional panorama viewer program and it also communicates with the module at the server to specify which portion of the panorama should be streamed to the client. The special module at the client has the ability to accept data that represents a portion of a series of panoramic frames, to decompress the data, to select the data that constitutes an appropriate view window and to render (i.e. display) a portion of each frame on a screen or display.

The server module selects particular slices that constitute a region of interest in the panorama and these slices are sent to the client. At the client, the user may select navigation commands such as pan left, pan right, pan up, pan down, roll left, roll right, zoom in, zoom out or a combination of these or other commands to change the view window. When the location of the view window is changed by more than a threshold amount, the client sends a command back to the web server. In response to the commands from the client, the server module adjusts the selection of the slices that are streamed from the server to the client. There may be many clients receiving information from a particular server and for every client, the module at the server maintains session information and streams appropriate information to that client.

### BRIEF DESCRIPTION OF THE FIGURES

FIG. 1 is a block diagram of first embodiment of the invention.

FIGS. 2A to 2D illustrate the movement of a region of interest and a view window in a panoramic image.

FIG. 3 is a block diagram of the program in the browser plug in.

FIG. 4 is a block diagram of the program in the server plug in.

FIG. 5 illustrates the shape of a view window relative to the slices in a panorama.

FIG. 6 shows an alternate form of panoramic image.

FIG. 7 shows an alternate embodiment of the invention wherein two different streams are being transmitted from the server to different clients.

FIG. 8 shows another alternate embodiment of the invention which utilizes a different type of server.

FIG. 9 shows an embodiment of the invention where the entire invention is operating on a single computer.

### DETAILED DESCRIPTION

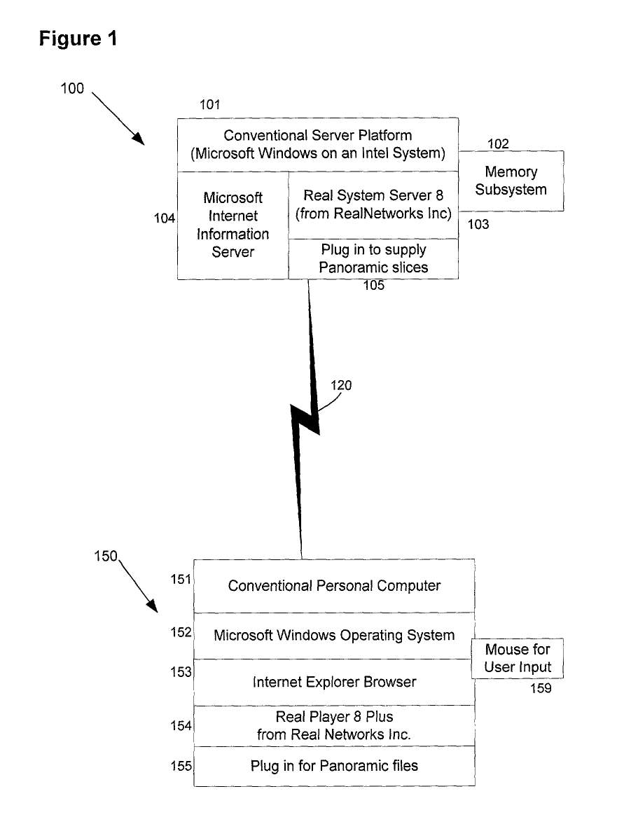

A first preferred embodiment of the invention is shown in FIG. 1. In this embodiment panoramic images are streamed from a server 100 to a client 150 over a network 120. The network 120 could for example be the Internet. While only a single client 150 is shown it will be understood by those skilled in the art that a single server 100 could provide data to a large number of clients 150.

The data streamed from server 100 to client 150 could for example be data from a panoramic movie of the type shown in co-pending application Ser. No. 09/310,715 filed May 12, 1999 entitled “Panoramic Movies which Simulate Movement Through Multidimensional Space”, the content of which is herby incorporated by reference. A panoramic movie consists of a series of panoramic images. Such a series of panoramic images could for example be a series of panoramas recorded by a multi lens camera which is moving along a street. A panorama is normally displayed by allowing a user to select a view window (i.e. the direction in which the user is looking). In a panoramic movie, this view window can change direction as a series of frames is projected. That is, with a panoramic movie, the user has the option of selecting the direction of view. The location of the view window in the panorama changes as the user changes direction of view.

With the present invention an entire panorama is not streamed from the server 100 to the client 150. Only that portion of the panorama (called a region of interest) that includes the view window and a surrounding region (i.e. a guard band) is streamed from the server 100 to the client 150. That is, the region of interest that is streamed from the server to the client includes the view window and a guard band around the view window. The user is provided with controls (e.g. a mouse 159) whereby the user can change the location of the view window in the panorama, that is, the user can change the area of the panorama that is being displayed. When the user changes the location of the view window by more than a threshold amount, the client sends a command to the server to change the location of the region of interest.

Data in the entire region of interest is transmitted from the server 100 to the client 150. The client therefore has the entire region of interest immediately available for display. The guard band surrounding the view window provides data that is immediately available for display at the client when the user moves the view window. Thus, the user can change (to some degree) the location of the view window in the panorama and the data needed to provide the changed display is immediately available without having to wait for the server to send different data.

Without the present invention, one could achieve the same result by streaming entire panoramas from the server 100 to the client 150; however, this would require significantly more bandwidth than is required by the present invention. Alternatively, only the data that is in the view window could be streamed from the server to the client; however, if this were done when the user gives a command to change the viewing direction (i.e. the location of the view window in the panorama), the command from the user would have to go from the client to the server and the server would have to begin streaming different data to the client 150. This would result in a delay between when the user gives a command and when the view window actually changes. It is noted that this delay is exacerbated by the fact that streaming systems normally buffer data at the server and at the client. Buffering is required for a number of reason including the need for multiple frames in order to perform decompression.

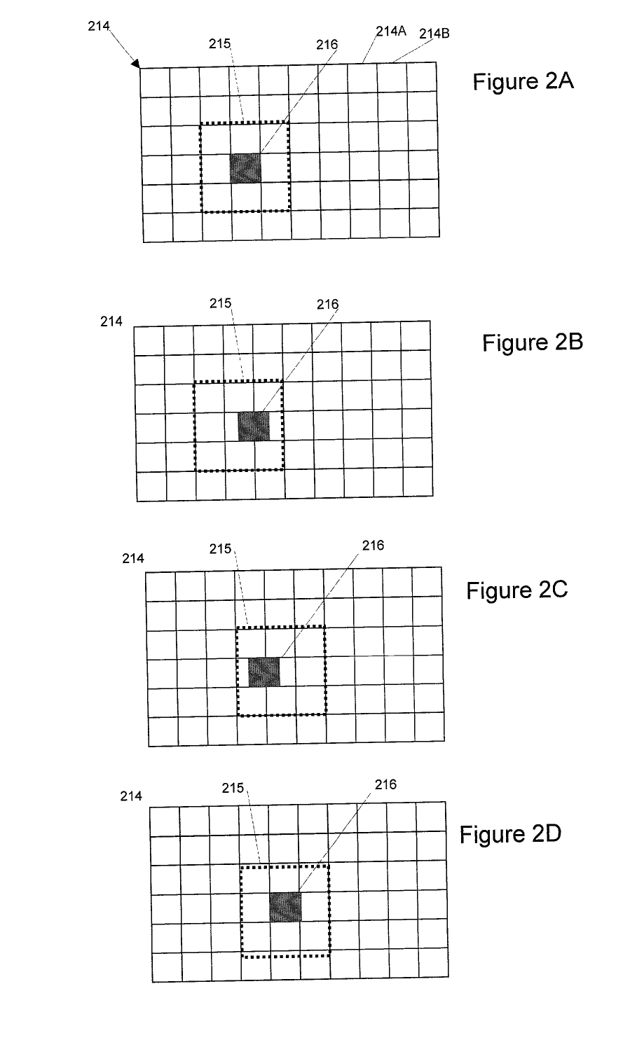

FIGS. 2A to 2D illustrate how changes in the location of the view window generates changes in the area of interest that is streamed from the server to the client. FIG. 2A illustrates one panorama 214. The panorama is divided into areas 214A, 214B etc. There is a region of interest 215 and the view window is 216. It is noted that the size of the areas in FIGS. 2A to 2D is exaggerated for purposes of illustration and they do not constitute actual MPEG slices. The actual sizes are explained later.

FIGS. 2A to 2D illustrate four frames in a panoramic video. It should be noted that the four frames shown in FIGS. 2A to 2D are not necessarily adjacent sequential frames. That is, out of a series of thirty frames, the frames (i.e. the panoramas) shown may be the first, tenth, twentieth and thirtieth frames. The changes in the intermediate frames will be a portion of the changes shown in FIGS. 2A to 2D.

For simplicity in illustration and ease of explanation in FIGS. 2A to 2D, the areas are shown as being square and the size of the view window is shown as coinciding with the size of an area. The actual size of the areas and actual shapes will be explained later. Furthermore, a panorama would normally include an image. For ease of illustration, in FIGS. 2A to 2D the areas are shown without showing the actual image.

The entire panorama 214 is not transmitted from the web server 100 to the client 150. Only a region of interest 215 from each frame is transmitted from the server to the browser. The region of interest 215 includes the particular view window 216 that is being displayed to the user.

When a user is looking at a particular view window in a panorama, the user might decide to change the location of the view window in the panorama. That is, the user might want to position the view window in a different part of the panorama so that a different part of the panorama will be visible on the display. The term “pan” means that a user changes the location of the view window in one direction or another.

Since the region of interest 215 includes a “guard band” surrounding the view window 216, and since the entire region of interest 215 is transmitted to the client 150, the data is available at the client 150 to allow the user to change the location of the view window (i.e. to change the portion of the panorama being displayed) without the need for any communication to the server 100.

FIG. 2B illustrates the view window 216 moving to the right. As the user changes the location of the view window 216, (i.e. as the user changes the portion of the panorama being displayed) the region of interest 215 is changed as shown in FIG. 2C. Motion by a user generally continues in the same direction for some time so the user might arrive at the location shown in FIG. 2D.

Each time the user changes the location of the view window by an amount which exceeds a certain threshold (which can be set depending on factors discussed later), the client 150 sends a message to the server 100 notifying the server of this change. When the server receives a signal indicating that the location of the view window has changed, the server changes (if appropriate) the particular slices being sent to the browser (i.e. the slices that constitute the region of interest) so that the slices transmitted always include the view window plus a guard band. Thus, the server continues sending a particular region of interest from each frame until notified to change by the client. A user can pan within this region of interest without waiting for the server to change the portion of the panorama that is being streamed from the server to the client.

Frames in a panoramic video are generally sent at a rate of thirty frames per second. Thus, the region of interest from a significant number of frames may be transmitted before the server receives and reacts to a command to change the region of interest. Since the guard band surrounds the view window, the user can change the location of the view window (to some extent) before the server has a chance to react to a command to change the location of the region of interest.

The size of the guard band does not have to be of a fixed size, or symmetrical around the region of interest. The guard band may be larger in an expected or usual direction of panning. For example, the guard band may be larger on the left and right sides of the view window, than at the top or bottom. The size of the guard band can be adjusted to an appropriate amount by tracking the history of usage by each particular user and the bandwidth available. Transmitting a larger region of interest requires more bandwidth. Furthermore, the viewer program may limit the rate at which the image is panned. This would be done to attempt to preserve smooth panning in return for a reduced pan rate.

The panoramic frames are compressed by the server 100 using standard MPEG compression. The MPEG standard specifies that slices are always 16 pixels high and that the width of a slice is a multiple of 16 pixels, up to the entire width of the frame. With the present invention it has been found that with a frame that is 2K by p1K, the frame can be divided into 8 slices horizontally each slice being 16 pixels tall, and 256 pixels wide. Thus, there would be 512 slices for each frame.

It is noted that “Slicing” is a term used in the MPEG 2 standard. In the MPEG 4 standard, the slicing mechanism is part of the error correction and concealment section of the standard, and it is known as “inserting resynchronization markers”, or “resynchronization mechanism”. While the terms used in the two standards differ somewhat the actual implementation is identical, since MPEG 4 carries over all of MPEG 2's implementation. Herein the term “slice” from the MPEG 2 standard is used; however, it should be understood that as used herein the term “slice” is intended to refer to “slices” from the MPEG 2 standard and to the equivalent mechanism in other MPEG standards.

MPEG compression uses “I” frames (Intra frames), “P” frames, and/or “B” frames. The I frames contain all of the information needed to reconstruct a single image. P (Predictive) frames copy the closest matching block of pixels from the preceding I or P frame, and add a (hopefully small) correction to create blocks. B (Bi-directional) frames are similar to P frames, but can also copy blocks from the future I or P frame, and/or can average a preceding and future block to create a block in the frame being constructed. I frames are relatively large, P frames are typically smaller, and B frames are usually the smallest. The construction and definition of I frames, B frames, and P frames is set out in the publicly available MPEG standards. The use of either B or P frames is chosen depending upon whether or not reverse motion is desired.

The I frames are considerably larger that the B or P frames. Thus, in the first embodiment, only slices from the region of interest in the I frames is transmitted from the client to the server and the entire B or P frames are transmitted. Alternatively only slices in the region of interest from the B frames could be transmitted. However, it is noted that the number of slices transmitted from the I or P frames may be larger than the number of slices transmitted from the B frames. The reason for this is that only the slices in the B frames that are in the region of interest need be transmitted. With respect to the I and P frames, both the slices in the region of interest and the slices needed by their dependent P and B frames must be transmitted. This imposes a requirement that when encoding P and B frames, blocks of pixels may only be copied from the corresponding slice of the referenced I or P frame, and perhaps the adjacent slice as well.

When motion is stopped and a user focuses on one frame, the bandwidth can be used to transmit the additional information and to store this additional information in a buffer just in case it is needed. In the situation where a user stops the motion of the video, freezing the view window on a portion of one frame, the system can transmit the entire panorama (or a relatively large portion thereof from the server to the browser, allowing the user full freedom to pan, tilt, etc., at full speed within the current panorama without need to send commands to the server. If the entire panorama (or a large portion thereof) is stored in a buffer at the client machine, moving the view window can be changed over a larger region more quickly.

In the first preferred embodiment of the invention shown in FIG. 1, server 100 consists of a conventional server platform with the “Microsoft Windows 2000” operation system 101. The system includes the commercially available “Real System Server 8” program 103 which is commercially available from RealNetworks Inc. The system includes a memory subsystem 102 which stores panoramic videos. The overall streaming operation is handled by the Real System Server 8; however, when the system is asked to stream a panoramic video, the file is passed to plug-in 105. The system shown in FIG. 1 also includes the Microsoft Internet Information Server 104. The Microsoft Internet Information Server 104 is not used during the streaming operation; however, it may handle a web site that allows a user to request that a particular panoramic movie be streamed. That is, a web site may list a set of available panoramic movies. When a user clicks on one of the listed movies, the system retrieves that files and begins sending the images to plug in 105.

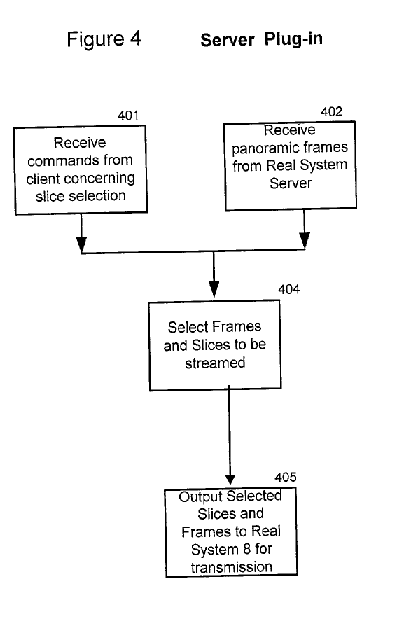

FIG. 4 is a program block diagram showing the operation performed by plug-in 105. The frames are stored in compressed format in memory system 102. When the system is asked to stream a panoramic video, the panoramic frames are passed to the plug-in 105 from real player 8. The system starts by transmitting a default region of interest from the panoramas with the view window located at a default location. Commands to change the region of interest are received from the client as indicated by block 401. As indicated by block 404, the slices which form the region of interest 216 are selected. As indicated by block 405, the selected slices are passed to the Real System 8 for transmission to the browser.

In the embodiment shown in FIG. 1, the client 150 consists of a personal computer 151 with the Microsoft Windows operating system 152, the Microsoft Internet Explorer Browser 153, and the Real Player 8 Plus program which is commercially available for Real Networks Inc. The system includes a user input device 159 such as a mouse. Finally the client 150 includes a plug in 155 which handles panoramic images.

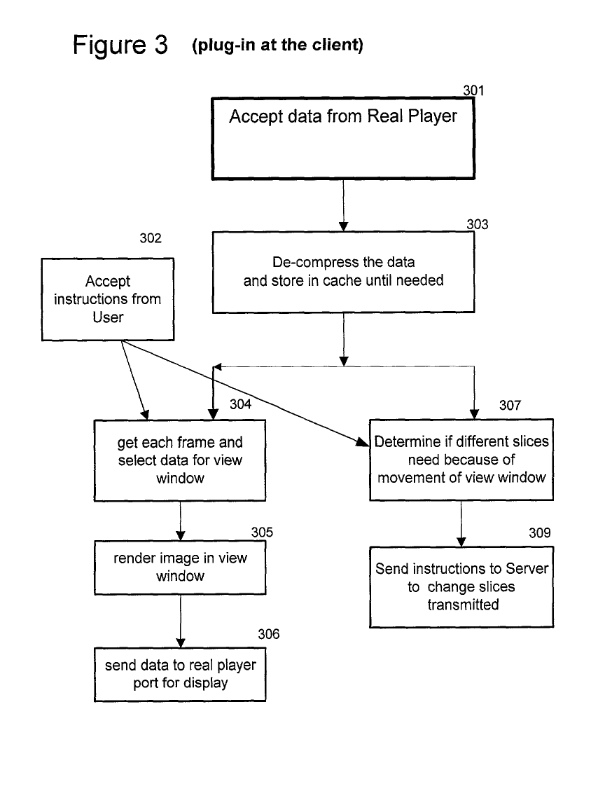

FIG. 3 is a block diagram of the program in plug in 155. Plug in 155 receives inputs from the user and from Real Player 8 as indicated by blocks 301 and 302. As indicated by block 303 the slices received from the server 100 are decompressed and stored. As indicated by block 304, the slices which constitute the view window are selected and this image is rendered as indicated by block 305 and sent to the real player 8 port for display as indicated by block 306. The view window from the panorama is rendered in a perspectively correct manner using the transformation known in the prior art for this purpose. Once the view window is determined the selection and rendering of the appropriate data is similar to the operation of many panoramic viewing programs.

The “Real System Server 8” and the “Real Player 8”, that is units 103 and 154 shown in FIG. 1, have what is called a “back channel”. The back channel is a communication channel that is separate from the channel used to stream the video frames. The back channel can accept data from the Real Player and send it to the Real System Server, or it can accept data from the Real System Server and send it to the Real Player. The back channel is regularly used to send a command such as Stop and Reverse from the player to the server. It is this back channel that is used to send data from client 150 to server 100 to instruct the server to change the region of interest. Naturally the plug-ins 105 and 155 includes the other conventional components that are specified by documentation for the plug in specification for the Real Player 8 and the Real System Server 8.

It is noted that the size of a view window will typically be on the order of the size of about twenty to eighty MPEG slices. As is know in the art, the actual size depends upon the size of the display and the characteristics of the particular viewer software. The size of the guard band around the view window will have a size in the range of 10 to 50 MPEG slices. Thus the areas shown in FIGS. 2A to 2D are the size of about ten to fifty MPEG slices.

As indicated by block 307, the plug-in determines if different slices are required to constitute the appropriate area of interest 215. This is done according to the following logic where “t” “x”, and “n” are variables the value of which is set as discussed below.

a) Has the view window changed by more a threshold amount “t”?

b) If the location of the view window has changed determine direction of movement.

c) When view window has moved by the threshold amount, move the region of interest “n” slices in that direction.

d) No further movement of the region of interest is necessary until the view window has moved a distance equal to “x” amount.

e) When the view window has moved “x” amount, revert to step “a”.

f) direction of movement changes, revert to step “b”.

g) If “action stopped” and user stops on a particular frame, instruct the server to send other slices to in effect enlarge the region of interest available at the client. This data is stored at the client.

The variables “t”, “x” and “n” can be initially set to default values and changed to suit the actions of a particular user and system. For example, the value of “t”, “x” and “n” can be in the order of the size of 5 to 50 slices. They can be set to one size and maintained at that size throughout a session or they can be changed during a session to make the system react to existing conditions. Initially they may be set to the value which is the size of 20 slices. If, for example, it is found that the system is experiencing a large amount of latency from when a command is send from the client to the server and when the server reacts, the values may be increased.

The above calculation takes place for both movement in the x direction and for movement in the “y” direction. As indicated by block 309 the instructions to change the slices that constitute the area of interest 215 are sent from the client 150 to the server 100.

As a specific example of how the system operates, consider a sequence of 500 panoramas in a panoramic move. Each panorama is 360 degrees in the horizontal direction and 180 degrees in the vertical direction, represented as an image with 2,048 (2K) pixels in the horizontal direction and 1,024 (1K) pixels in the vertical direction, for a total of 2,097,152 (2M) pixels per panorama.

When compressed this movie might consist of one “I” frame followed by nine “B” frames, followed by another “I” frame, nine “B” frames, etc. Each frame would be divided into 1024 slices, 16 slices horizontally by 64 slices vertically, each slice having a size of 16 pixels vertically by 128 pixels horizontally.

Assume a default view window centered vertically and horizontally within the panorama of approximately 90 degrees horizontally by 45 degrees vertically. Ignoring, for simplicity, the slight panoramic distortion that occurs about the horizon of the stored panoramic image, the view window would be represented by a region of 512 (2048/(360 degrees/90 degrees)) pixels horizontally by 256 (1024/(180 degrees/45 degrees)) pixels vertically, or 4 slices horizontally by 16 slices vertically. Assuming a guard band of one slice all the way around the view window, the initial region of interest of each frame having a size of 6 (4+2) slices by 18 (16+2) slices would be transferred from the server to the client.

In a simple example, if the user moved the view window 45 degrees to the right, the client would tell the server to shift the region of interest by two columns of slices to the right. If the user moved the window only 10 degrees to the right, the client would tell the server to add one additional column of slices on the right side of the region of interest, expanding the region of interest in order to preserve a guard band of at least one slice all the way around the view window.

The above described embodiment does not take into account the rate at which the user is panning. A more sophisticated embodiment could add additional computational ability to take into account the rate at which the user pans the view window. This added logic could be added at either the server or the client. The following example is based on the logic for rate being at the server. In such a situation the system would operate as follows: Assume that the user starts panning to the right at a rate of 4.5 degrees per frame. The client plug-in would communicate this rate back to the server. Periodically, the client would also communicate back to the server the actual current position of the view window. The server would use this information to predict the probable range of locations the view window may have by the time each frame is actually displayed, and send the slices which cover this range (plus a suitable guard band). Thus, when sending the first “I” frame, the server would send the slices covering the current region of interest and all of the slices anticipated up to where the region of interest will probably be located at the time when the next “I” frame is displayed.

In the above example, this would add two columns of slices to the right, since by the time the next “I” frame is reached, the panning may have progressed through 45 degrees. The first “B” frame following this “I” frame will need to transmit only the same 6 by 18 slice region as transmitted from the “I” frame, since the anticipated motion would not have moved too far. For the next 4 “B” frames, the slices covering the 7 by 18 slice region (adding an additional column to the right) would be sent, and the final 4 “B” frames would include all slices in the 8 by 18 slice region (adding two additional columns to the right). The next “I” frame would need to include a 10 by 18 slice region, in anticipation that it would need to cover the possible motion of the previous “B” frames as well as the future “B” frames. As the server receives information on the actual position of the view window, it may be able to reduce the number of slices transmitted by adjusting the size of the guard bands to correspond to the most recent actual, vs. predicted, position.

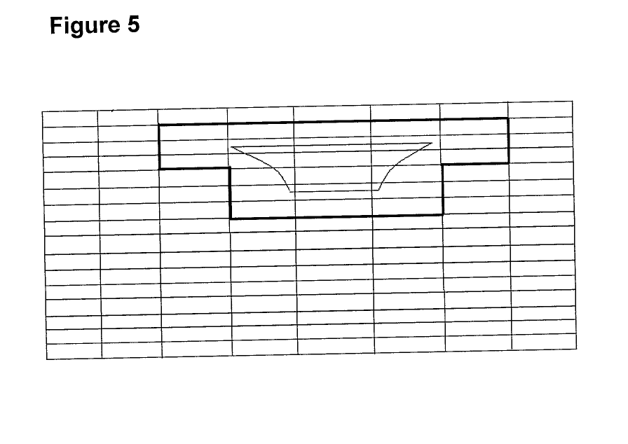

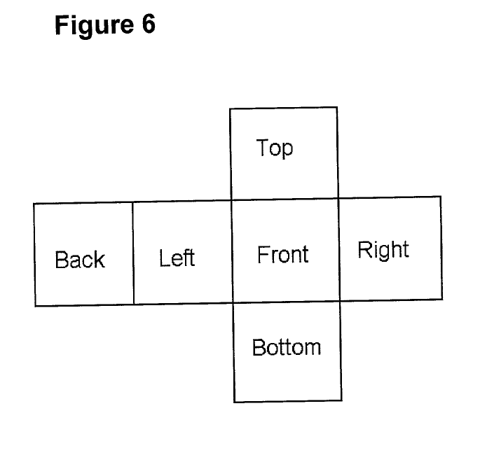

FIGS. 2A through 2D show rectangular view windows and guard bands. Rectangular shapes are shown to simplify the illustration and explanation. If a panoramic image is, for example, stored in an equirectangular format, the view window and the guard band would typically have the shape shown in FIG. 5. A common example of an equirectangular image is that of a rectangular map of the surface of the earth. The trapezoidal-like area shown in FIG. 5, when perspectively corrected, will result in a rectangular view window. The technique presented in this document can also be used if the image is stored in cubic projection form such as that shown in FIG. 6.

The embodiment of the invention described above utilizes I frames and B frames. The invention could also be applied using I frames and P frames. In another embodiment the invention can be implemented using fractal compression techniques instead of MPEG compression. Other streaming media platforms such as Microsoft's Windows Media or Apple's Quick Time or similar streaming media platforms could be used.

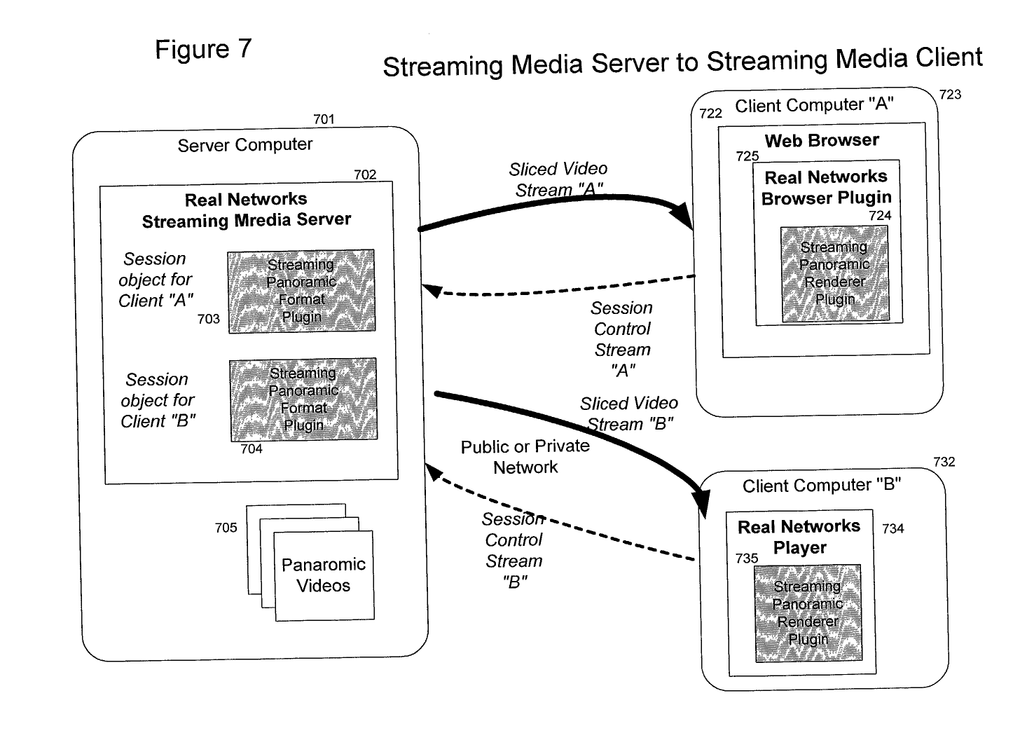

FIG. 7 illustrates an embodiment of the invention, where the server has two sessions operating and different streams are transmitted to two different client machines. In this embodiment the server 701 has a real Networks server 702 which has two plug-ins 703 and 704. Each plug-in 703 and 704 can stream a different series of panoramic images to browsers such as 723 and 724.

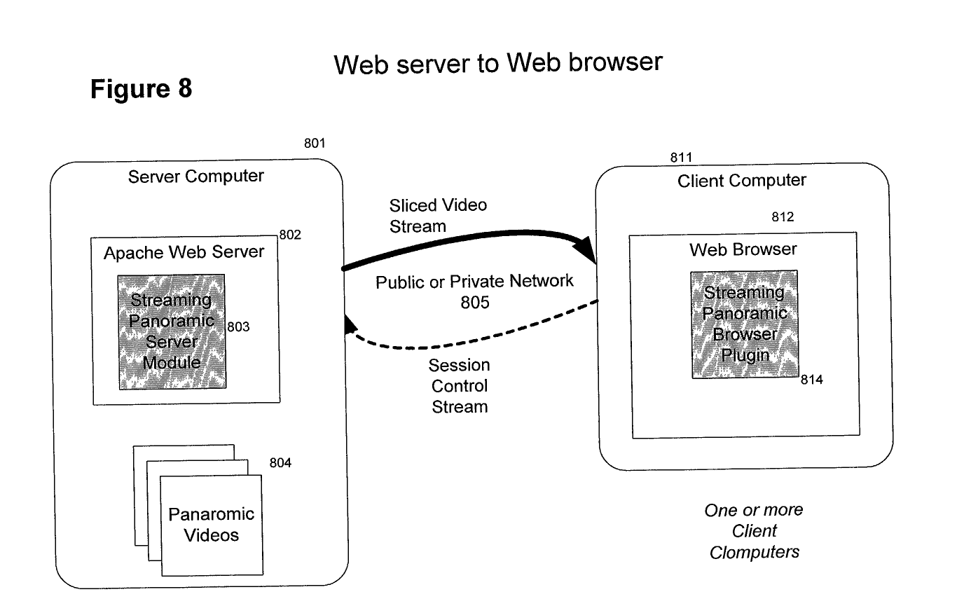

Another embodiment of the invention is illustrated in FIG. 8. In the embodiment illustrated in FIG. 8, the server 801 includes a conventional Apache Web server 802. A module 803 termed the Streaming Panoramic Server Module streams slices as previously described to the client 811. The client application in this embodiment is a standalone application 812 that contains the functional capabilities of the client plug-in 155 in the first embodiment.

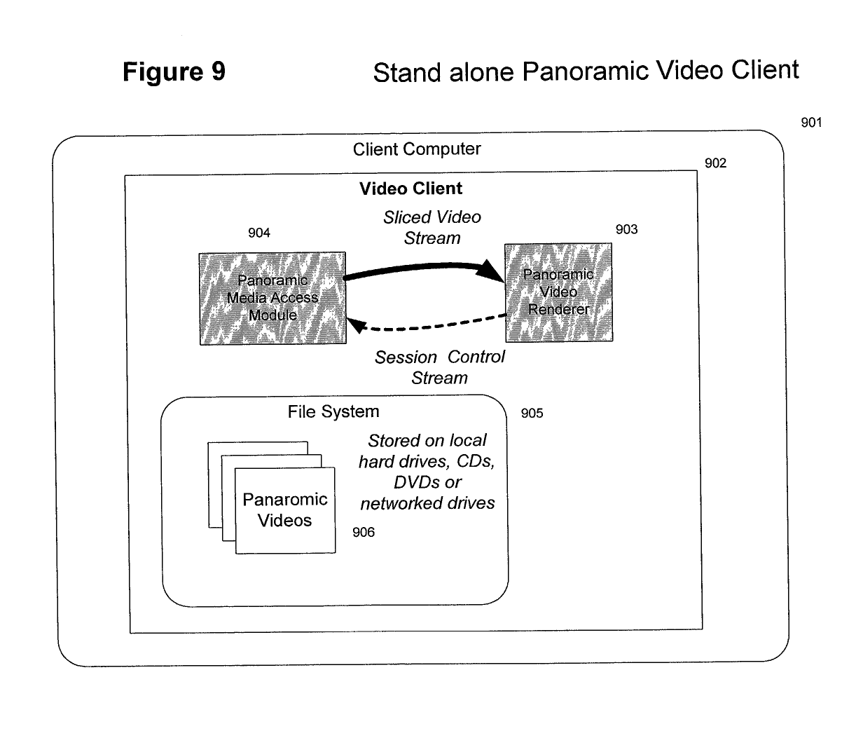

Another embodiment of the invention is shown in FIG. 9: In this embodiment a “Stand Alone Panoramic Video Client” 902 is used. In this embodiment, the function of the server module and the client plug-in are co-located on the same computer. The server component 904 called the “Panoramic Media Access Module” retrieves and reads the desired panoramic video from a file system 905 that could be local hard drives, CDs, or a networked file system. This module 904 slices the panoramic video frames in the same way as described in the first embodiment and is functionally equivalent to the module 105 in the first embodiment. The “Panoramic Video Renderer” 903 takes the sliced video frames and renderers the image to the screen in the same ways as the plug-in 155 in the first embodiment. The “Sliced Video Stream” is equivalent to that described in the first embodiment. In this case, the stream is passed via an inter-process communications mechanism that could include shared memory, pipes, sockets or an equivalent mechanism instead of being streamed through a public or private network. The “Session Control Stream” is the same as the other embodiments and consists of instructions on how to slice the Video stream as it is read from the file system

While the invention has been shown and described with respect to preferred embodiments thereof, it should be understood that a wide variety of changes may be made without departing from the present invention. The scope of the invention is limited only by the appended claims:

I claim:

1. A method of streaming a panorama from a server to a client, wherein a user can only see the portion of the panorama in a view window and the user can move the location of the view window in the panorama, said method comprising the steps of
dividing the panorama into slices,
transmitting from the server to the client slices of said panorama that contain the view window plus a guard band surrounding the view window,
transmitting from the client to the server instructions to change the location of said guard band as said user moves said view window.

2. The method recited in claim 1 wherein said slices are the slices defined in the MPEG standard.

3. The method recited in claim 1 where the streaming from the server to the client is handled by a streaming server and a plug-in to said server provides the slices in said guard band.

4. The method recited in claim 1 where the client and the server are located on the same physical machine.

5. The method of streaming data relative to a series of panoramic images from a server to a client, whereby a view window of said client can be displayed to a user, said method comprising the steps of:
dividing each of said panoramic images into areas,
streaming a plurality of said areas from each area from said server to said client, said plurality of areas including said view window and a guard band around said view window,
displaying said view window portion of said panorama at said client,
accepting user directions to change the location of said view window,
sending commands to said server to change said plurality of areas being streamed to said server when said view window is changed more than a threshold amount, and
changing the areas streamed from said server to said client in response to said commands.

6. The method recited in claim 5 wherein said areas are MPEG slices.

7. The method recited in claim 5 wherein said server is a Real Networks server.

8. The method recited in claim 5 wherein said panorama is displayed to said user in a perspectively correct manner.

9. The method recited in claim 5 wherein said server simultaneously streams portions of different panoramas to different clients.

10. The method recited in claim 5 wherein said server and said client are on the same physical machine.

11. A system for transmitting panoramic images from a server to a client,
means at said server for dividing each panorama into areas, a plurality of said areas forming a region of interest of said panorama, said region of interest including a view window and a guard band around said view window,
means for transmitting a region of interest from each panorama in a series of panoramas from said server to said client,
means at said client for moving the location of said view window in said panorama,
means for transmitting from said client to said server commands to change the location of said region of interest, and
means at said server for changing the location of said region of interest which is streamed to said client.

12. The system recited in claim 11 where each of said areas comprise a plurality of MPEG slices.

13. The system recited in claim 12 wherein said server simultaneously streams portions of different panoramas to different clients.

14. The system recited in claim 12 wherein said server and said client are on the same physical machine.

15. The system recited in claim 12 wherein all said means are physically located on one physical system.

16. A system for allowing a series of panoramic images stored at a server to be viewed by a user at a client, said system including,
a streaming server at said server for streaming data to said client,
a program at said server for providing said streaming server with an area of interest from each panorama to be streamed to said client, said area of interest including a view window and a guard band around said view window, and
a program at said client for receiving said data and for selecting the data representing said view window and for displaying said view window to said user.

17. The system recited in claim 16 including a user input device whereby said user can move said view window in said area of interest, and a communication path from said client to said server whereby said client can instruct said server to change the location of said view window.

18. The system recited in claim 17 wherein said user input device is a computer mouse.

19. The system recited in claim 15 wherein said panoramic images are stored at said server using MPEG compression forming “I” and “B” or “P” frames.

20. The system recited in claim 19 wherein the region of interest from “I” frames and entire “B” or “P” frames are transmitted from said server to said client.
